(19) United States
(12) Patent Application Publication
(10) Pub. No.: US 2021/0238854 A1
(43) Pub. Date: Aug. 5, 2021

(54) ROOF OR WALL HOLE CLOSING DEVICE

(71) Applicant: Celtic Heights Limited, Penzance Cornwall (GB)

(72) Inventor: Nigel INCH, Penzance (GB)

(73) Assignee: Celtic Heights Limited, Penzance Cornwall (GB)

(21) Appl. No.: 15/734,870

(22) PCT Filed: Jun. 3, 2019
(86) PCT No.: PCT/GB2019/051529

§ 371 Date: Dec. 3, 2020

(30) Foreign Application Priority Data
Jun. 4, 2018 (GB) 1809122.3

(51) Int. Cl. E04D 3/36; E04D 15/00; E04D 13/076; E04G 23/02

(52) U.S. Cl. CPC E04D 3/3605; E04G 23/0281; E04D 13/076; E04D 15/006

(57) ABSTRACT

or Wall Hole Closing Device A roof or wall hole closing device 1 comprises an expanding part 3 which, in its contracted condition, is passed through the hole from one side. The expanded part 3, when expanded, closes the hole from one side. A rod 5 passes into the expanding part 3. The expanding part 3 is expanded by the user pulling the rod 5 through the hole. A lower seal engages against a second side of the hole to prevent movement of the expanding part 3 from its closing position. The device when used in a roof can be installed from below, which avoids the dangers of the user needing to go up onto the roof.

The present invention relates to roof or wall hole closing devices, such as roof or wall hole closing anchors, and particularly to devices for closing holes in roof panels.

In this specification, “an anchor” means a device that fixes to a structural member such as a roof or wall panel to provide a fixing point for another object then to be fixed to the structural member.

Roofs typically have a framework of joists and purlins. In commercial and industrial buildings, corrugated outer roofing panels are typically fixed to the purlins using hook bolts. The installation of typical hook bolts requires the installer to go up onto the roof to tighten the nut into position. This is dangerous for the installer because of the risk of falling off the roof or through a roof panel. It is also costly because of the large amount equipment (much of it for safety) needed to work on the roof from above. It has therefore been desired to find a way of installing or changing roof panels from below i.e. from inside the building.

UK patent number 2459381 discloses a method of replacing a roof panel from below. In the method, a working platform is positioned below the panel to be replaced, for example using a cherrypicker, and the installer stands on the platform and removes the bolts and fasteners securing the roofing panel. The roofing panel is then removed, holes are drilled in the new panel using the old roof panel as a guide. Before the new panel is secured, bolts must be threaded through the panel from above. Once the panel is in position in the roof, the bolts need to have additional components screwed on to their lower ends to secure the bolts to the new roof panel and to attach the hook. There are many different steps involved in this method which makes it time consuming to carry out.

The invention aims to mitigate at least one of the disadvantages of the prior art.

In a first aspect of the present invention, a roof or wall hole closing device is provided, the device comprising: an expanding part to close the hole from one side, the expanding part being expandable from a first, contracted condition in which it can be passed through the hole, to a second, expanded condition in which it cannot be passed through the hole and in which it covers and closes the hole in a covering and closing position on a first side of the hole, the expanding part having an inner part and an outer sealing part, and during expansion of the expanding part the inner part moves laterally outwards which moves the outer sealing part laterally outwards; a member passing into the expanding part, the expanding part being expandable by pulling the member in an outwards direction with respect to the expanding part through the expanding part and through the hole; and a positioner to engage against a second side of the hole to prevent movement of the expanding part from its covering and closing position in its second, expanded condition.

The device can be installed from only one side (the second side referred to above) of the hole. This means that the installer does not need access to the other side (the first side referred to above). In a roof, the device can be installed from below the roof and inside the building. This means the installer avoids the dangers of going up onto the roof associated with the prior art devices.

The device can be used to close a hole in a roof panel where a previous fixing has failed. In contrast to the disclosure of UK patent number 2459381, the device of the first aspect of the present invention does not need the roof panel to be completely removed in order to install the device. One or more of the devices can be installed from below while the panel remains in position, thereby saving time and expense. Furthermore, the installer may not require such a high level of skill because he or she does not need to be able to remove the panel from its position in the roof.

The device is installed by pulling the member through the expanding part. This makes it considerably quicker and easier to install compared to devices installed by screwing.

Movement of both the inner and outer parts laterally outwards results in a large expansion and good covering by the expanding part.

The device may be configured so that the expanding part in its second, expanded condition and the positioner compress the roof or wall part which has the hole so that the expanding part provides a tight seal against the roof or wall part to prevent ingress of water.

In one preferred form, substantially all of the perimeter of the expanding part moves laterally outwards during expansion so that the expanding part covers the entire perimeter of the hole in the covering position on the first side of the hole in the second, expanded condition.

The device may be configured so that, when the expanding part is in its second, expanded condition, the member is not retracted into the expanding part upon release of the pulling.

The device may be a roof or wall hole closing anchor. In that case, the inner part of the expanding part may not move laterally outwards during expansion of the expanding part, and may instead move longitudinally in the direction in which the member is pulled.

In a second aspect of the present invention, a roof or wall hole closing anchor is provided, the anchor comprising: an expanding part to close the hole from one side, the expanding part being expandable from a first, contracted condition in which it can be passed through the hole, to a second, expanded condition in which it cannot be passed through the hole, substantially all of the perimeter of the expanding part moving laterally outwards during expansion so that the expanding part covers the entire perimeter of the hole and closes the hole in a covering and closing position on a first side of the hole in the second, expanded condition; a member passing into the expanding part, the expanding part being expandable by pulling the member in an outwards direction with respect to the expanding part through the expanding part and through the hole; and a positioner to engage against a second side of the hole to prevent movement of the expanding part from its covering and closing position in its second, expanded condition, the device being configured so that, when the expanding part is in its second, expanded condition, the member is not retracted into the expanding part upon release of the pulling.

The device can be installed from only one side (the second side referred to above) of the hole. This means that the installer does not need access to the other side (the first side referred to above). In a roof, the device can be installed from below the roof and inside the building. Therefore, the installer avoids the dangers of going up onto the roof associated with the prior art devices.

The device can be used to close a hole in a roof panel where a previous fixing has failed. In contrast to the disclosure of UK patent number 2459381, the device of the second aspect of the present invention does not need the roof panel to be completely removed in order to install the device. One or more of the devices can be installed from below while the panel remains in position, thereby saving time and expense. Furthermore, the installer may not require such a high level of skill because he or she does not need to be able to remove the panel from its position in the roof.

The member may protrude from the hole on the second side of the hole (that is, internally of the building) when the expanded part is expanded and provide a point for anchoring objects to the roofing panel or wall panel which has the hole, or a point by which the roofing panel or wall panel can be anchored to another object on the second side of the hole. For example, in the case of a roofing panel, the roofing panel may be anchored to a purlin. The roofing panel would then be fixed and prevented from lifting off the roof. The member may also protrude in this way in the device of the first aspect.

Alternatively or additionally, the member may extend from the expanding part away from the hole on the first side of the hole (that is, externally of the building, and upwards in the case of a hole in a roof) when the expanded part is expanded and provide a point for anchoring objects to the roofing panel or wall panel. For example, solar panel mountings, guttering or other external fittings can be anchored to the roofing panel. This avoids the need for additional fixing holes to anchor those fittings. The member may also extend in this way in the device of the first aspect.

In the second aspect, the anchor may be configured so that the expanding part in its second, expanded condition and the positioner compress the roof or wall part which has the hole so that the expanding part provides a tight seal against the roof or wall part to prevent ingress of water.

In the first or second aspect, preferably, when the member is pulled to expand the expanding part, the member moves relative to the positioner. This means the positioner is in a position to engage the second side of the hole as soon as the expanding has expanded, so no extra step is required to engage the positioner. The member is preferably pulled through the positioner. The member preferably can slide with respect to the positioner.

In the first or second aspect, the positioner preferably comprises a resilient material. This allows the positioner to be engaged tightly against a second side of the hole. It also allows the device to be used with holes in panels of a range of thicknesses. The resilient material may be an elastomeric material such as rubber.

In the second aspect, in one preferred form, the expanding part has an inner part and an outer sealing part, and during expansion of the expanding part the inner part moves laterally outwards which moves the outer sealing part laterally outwards.

Movement of both the inner and outer parts laterally outwards results in a large expansion and good covering by the expanding part.

The following optional features are applicable to the first and second aspect of the invention unless indicated otherwise.

The device may be a roof or wall hole sealing device or plug. This can be used to seal leaking holes quickly and easily in roofs or walls.

In the first and second aspect, the device can be used with panels made of range of materials such as glass, metal, asbestos and plastic.

During expansion, preferably an external lateral dimension of the expanding part increases, preferably an external lateral dimension of each of the inner and outer parts increases.

The outer part may form a sleeve over the inner part. The outer part may be made of a resilient material.

The outer sealing part may be folded when the expanded part is in the first, contracted condition, preferably to form at least one fold running longitudinally. The at least one fold unfolds during expansion. “Longitudinally” means generally perpendicular to the lateral direction.

Preferably, the inner part of the expanding part comprises a plurality of legs which bend laterally outwards during expansion. Preferably, there is an even number of legs, for example four legs. Preferably the legs are equally spaced. This helps the expanding part sit on an undulating roofing panel, with a leg or legs on each side of the “peak” of the undulation when the anchor passes through the “peak”.

The outer sealing part of the expanding part may comprise an elastomeric material. The elastomeric material may be rubber.

The expanding part may comprise an elastomeric material.

The member can preferably slide with respect to a portion of the expanding part during expansion of the expanding part.

Preferably, when the expanding part is in its second, expanded condition, the expanding part is flexible so as to allow some movement of the roof or wall part which has the hole with respect to the member.

The member may pass through the expanding part.

The expanding part may plastically deform so that the member is not retracted into the expanding part, when the expanding part is in its second, expanded condition, upon release of the pulling.

Preferably, the positioner comprises a stop which prevents movement of the member relative to the positioner in order to prevent movement of the expanding part from its covering position in which it closes the hole.

The stop may be provided to prevent the member being retracted into the expanding part, when the expanding part is in its second, expanded condition, upon release of the pulling.

The stop may engage the member to prevent the member being retracted. The stop may lock against sliding along the member in one direction to prevent the member being retracted.

Preferably, the stop can slide along the member in the other direction. This may require considerable force. Preferably, the stop has teeth that engage the member, and is preferably is a washer or plate with such teeth. Preferably, the stop is a slip lock.

The positioner may comprise a seal to seal the second side of the hole. The seak preferably comprises a resilient material. This allows the seal to be engaged tightly against a second side of the hole. The resilient material may be an elastomeric material such as rubber.

The device may be configured so that the expanding part in its second, expanded condition and the positioner compress the roof or wall part which has the hole so that the seal of the positioner provides a tight seal against the roof or wall part to prevent ingress of water.

The seal may be configured to be received within the hole. A lateral external dimension of the (internal) seal may increase, preferably gradually, away from the expanding part, so that the seal forms, for example, part of a cone. This allows the seal to be used in holes of different sizes.

The seal may be configured to engage the roof or wall part which has the hole outside the perimeter of the hole. A lateral internal dimension of the (external) seal may decrease, preferably gradually, away from the expanding part, so that the seal forms, for example, part of a cone.

This internal or external seal preferably comprises a resilient material. This allows the seal to be engaged tightly against a second side of the hole. The resilient material may be an elastomeric material such as rubber.

The member is preferably a rod or shaft.

A nut or cap is preferably attached over the free end of the expanding part. Preferably, the nut or cap is attached over an end of the member.

In the first or second aspect, the device preferably comprises an attachment part connected to the member so as to be supported by the member, for attaching an object to the anchor on the second side of the hole.

The attachment part is preferably configured to engage or receive a part of a roof framework to attach the roof framework to the anchor. The part of roof framework may be a beam such as a purlin.

The attachment part may comprise a hook.

Preferably, the position of the attachment part relative to the member is adjustable by pulling the attachment part along the member or away from the hole.

Preferably:
the attachment part has an axis;
the member is configured to extend away from the hole on the second side of the hole when the anchor is anchored in the hole;
the member has an axis in the direction in which it extends; and
the orientation of the attachment part is adjustable so as to adjust an angle between its axis and the axis of the member.

Optionally, the device has a passageway having an inlet and an outlet, the passageway passing through the expanding part, the inlet and the outlet being arranged so that liquid can pass from the inlet on the second side of the hole, through the hole and expanding part to the first side of the hole, and out of the outlet only when the liquid reaches the side of the expanding part away from the hole.

In a third aspect of the present invention, a roof or wall hole anchor is provided, the anchor comprising: a member configured to extend away from the hole on one side of the hole when the anchor is anchored in the hole, the member having an axis in the direction in which it extends; and an attachment part connected to the member so as to be supported by the member, for attaching an object to the anchor on the one side of the hole, the attachment part having an axis, wherein the orientation of the attachment part is adjustable so as to adjust an angle between its axis and the axis of the member.

When using known anchors to anchor roof panels to structural members such as purlins, it is often necessary that the roof panel and the purlin have a particular orientation for the anchor to provide secure attachment. Without that particular orientation, secure attachment may not be possible. The anchor of the third aspect of the present invention allows adjustment of the orientation of the attachment part with respect to the member. This means that the attachment part can be securely attached to an object when the object (such as a purlin) and the roof or wall part with the hole have a range of different orientations.

In the third aspect, the orientation of the attachment part is adjustable so as to adjust an angle between its axis and the axis of the member. Accordingly, the orientation of the attachment part is adjustable in a plane including the axis of the member.

Preferably, a pivot is provided which allows adjustment of the orientation of the attachment part.

Preferably, a ball joint is provided which allows adjustment of the orientation of the attachment part.

Preferably, the ball of the ball joint can be clipped into the socket of the ball joint.

The ball may be removable from the socket of the ball joint.

The position at which the attachment part is connected to the member may be adjustable. The position may be adjustable by pulling in direction in which member extends.

The angle between the axis of the attachment part and the axis of the member may be at least 10, 20, 30, 40, 45, 50, 60, 70, 80 or 90 degrees.

The orientation of the attachment part may be adjustable in two perpendicular planes each including the axis of the member.

Preferably, the attachment part comprises a hook.

A stop may be provided which limits movement of the attachment part with respect to the member. Preferably, the stop limits movement away from the hole. Preferably, the stop engages the member or locks against sliding along the member in one direction.

Preferably, the stop can slide along the member in the other direction. This may require considerable force. Preferably, the stop has teeth that engage the member, and is preferably is a washer or plate with such teeth. Preferably, the stop is a slip lock.

The preferable features of the stop of the first aspect and second aspect are equally applicable to the third aspect of the invention. In addition, the features of the first and second aspect can be combined with those of the third aspect.

In a fourth aspect of the present invention, a roof or wall hole closing device is provided, the device comprising: an expanding part to close the hole from one side, the expanding part being expandable from a first, contracted condition in which it can be passed through the hole, to a second, expanded condition in which it cannot be passed through the hole and in which it covers and closes the hole in a covering and closing position on a first side of the hole; and a positioner to engage against a second side of the hole to prevent movement of the expanding part from its covering and closing position in its second, expanded condition, wherein the device has a passageway having an inlet and an outlet, the passageway passing through the expanding part, the inlet and the outlet being arranged so that liquid can pass from the inlet on the second side of the hole, through the hole and expanding part to the first side of the hole, and out of the outlet only when the liquid reaches the side of the expanding part away from the hole.

The device allows liquid to flow from the second side of the hole inside the building to the first side of the hole outside the building when the device is connected to a source of liquid. The liquid could be for example weed killer for clearing a roof of vegetation, or water for flushing out gutters. Again, this avoids the dangers and costs of the user needing to go up onto the roof.

The device prevents the liquid from flowing out of the device before it reaches the side of the expanding part away from the hole. This allows the device to close the hole effectively and helps to prevent liquid from flowing back through the hole. Thus, the liquid is directed more effectively to the outside, for example onto the outer surface of a roof or wall.

The passageway may pass through the positioner.

The device of the fourth aspect preferably further comprises a one-way valve in the passageway between the inlet and the outlet, to prevent liquid from passing from the outlet to the inlet. This makes the device watertight so that the device seals the hole. Accordingly, the device acts as a roof or wall hole sealing device or plug.

Preferably, the one-way valve is on the side of the expanding part away from the hole. This minimises the amount of rainwater that can build up in the passageway.

Preferably, the device further comprises a member passing through the expanding part, the expanding part being expandable by pulling the member in an outwards direction with respect to the expanding part through the expanding part and through the hole,
wherein the passageway passes through the expanding part inside the member.

Here, the member performs two functions: a “pulling function” and a “liquid directing function”. The passageway may pass along the length of the member. The member may be a hollow shaft. The member may pass through the positioner.

Preferably, the expanding part provides a seal against ingress of water.

The preferable features of the first and second aspects referred to above are equally applicable to the fourth aspect. Conversely, the preferable features of the fourth aspect of the invention referred to above are equally applicable to the first and second aspects.

Preferred embodiments of the invention will now be described, purely as examples, with reference to the drawings in which:

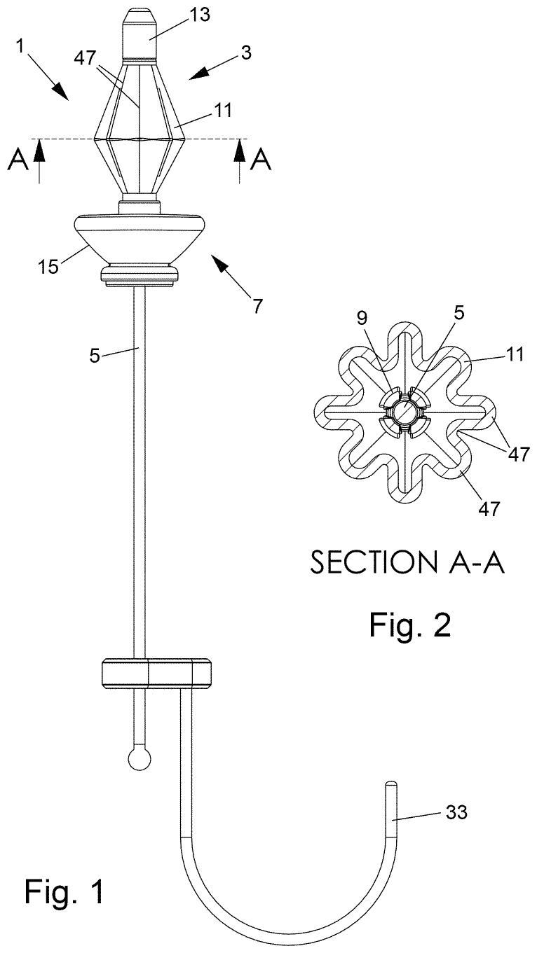

FIG. 1 is a side elevation view of the anchor according to the first embodiment of the invention in stage 1;

FIG. 2 is a cross-sectional view along A-A in FIG. 1;

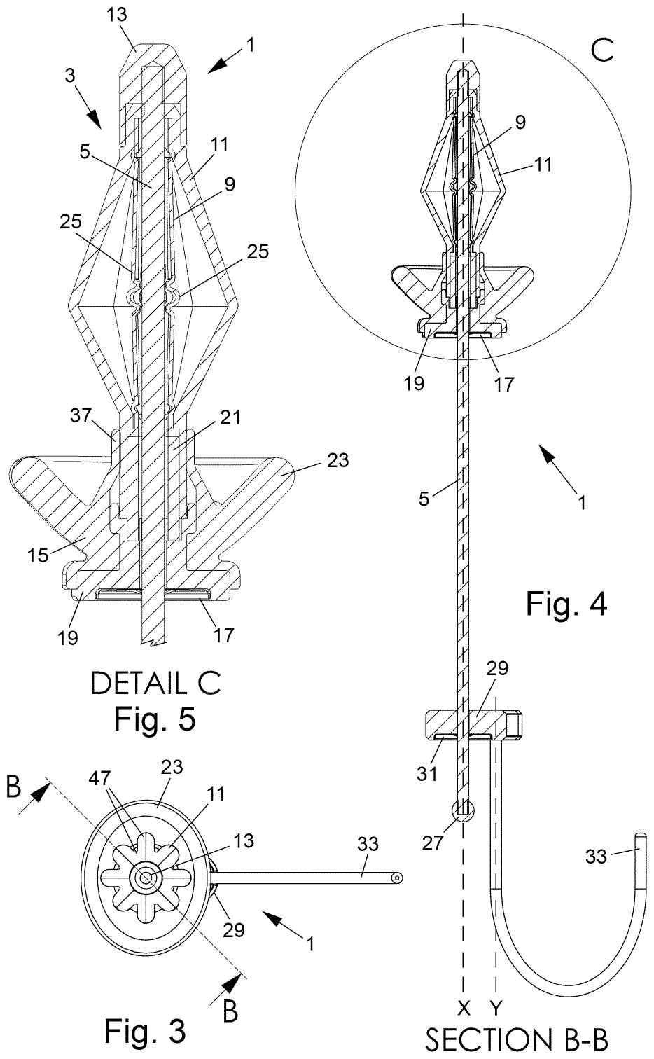

FIG. 3 is a top plan view of the anchor of FIG. 1;

FIG. 4 is a cross-sectional view along B-B in FIG. 3;

FIG. 5 is fragmentary view of FIG. 4 showing Detail C;

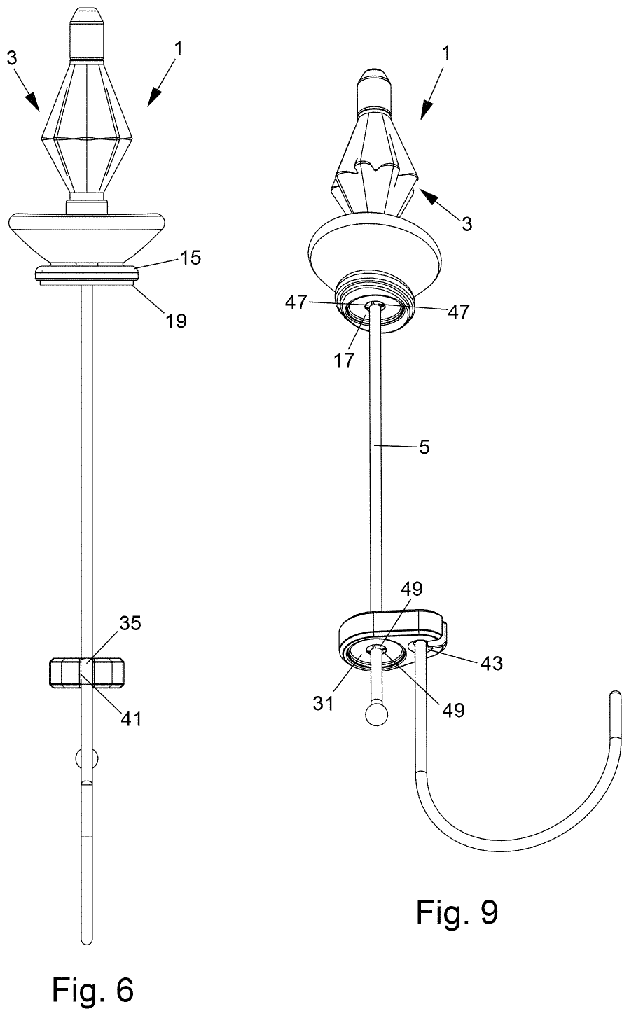

FIG. 6 is a front elevation view of the anchor of FIG. 1;

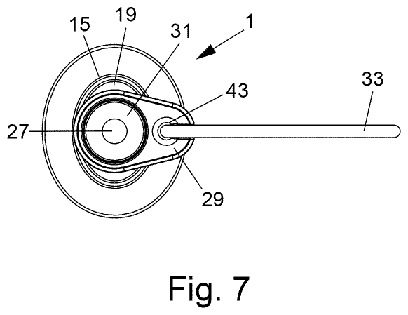

FIG. 7 is a bottom view of the anchor of FIG. 1;

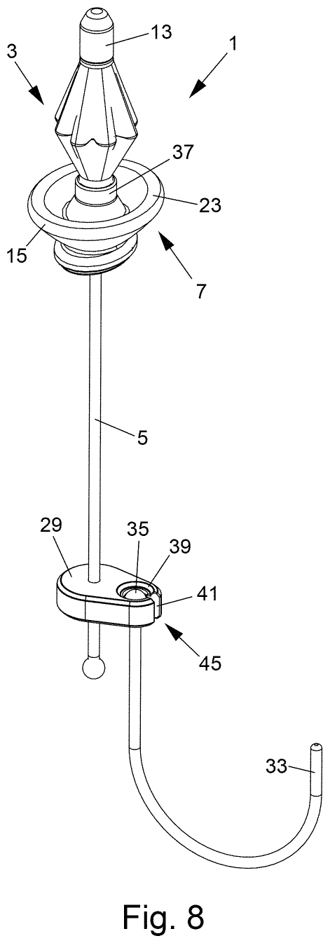

FIG. 8 is an isometric view from above of the anchor of FIG. 1;

FIG. 9 is an isometric view from below of the anchor of FIG. 1;

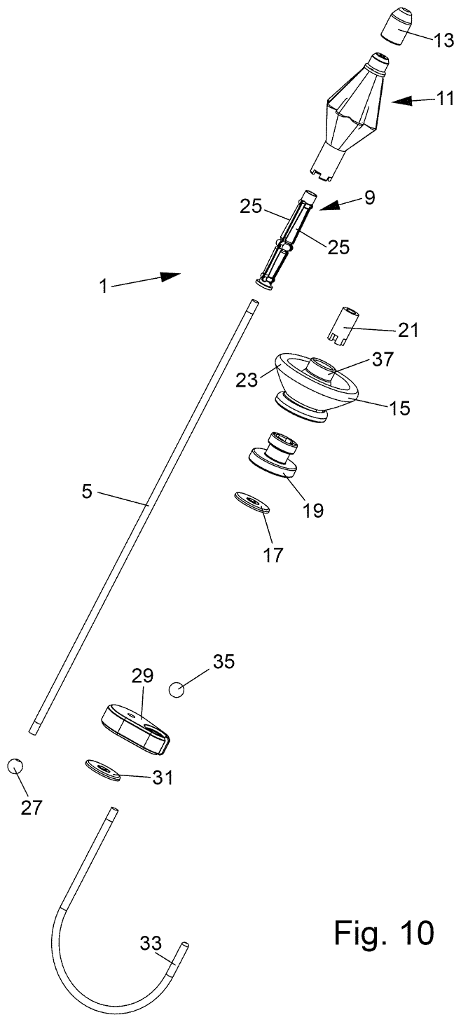

FIG. 10 is an exploded view of the anchor of FIG. 1;

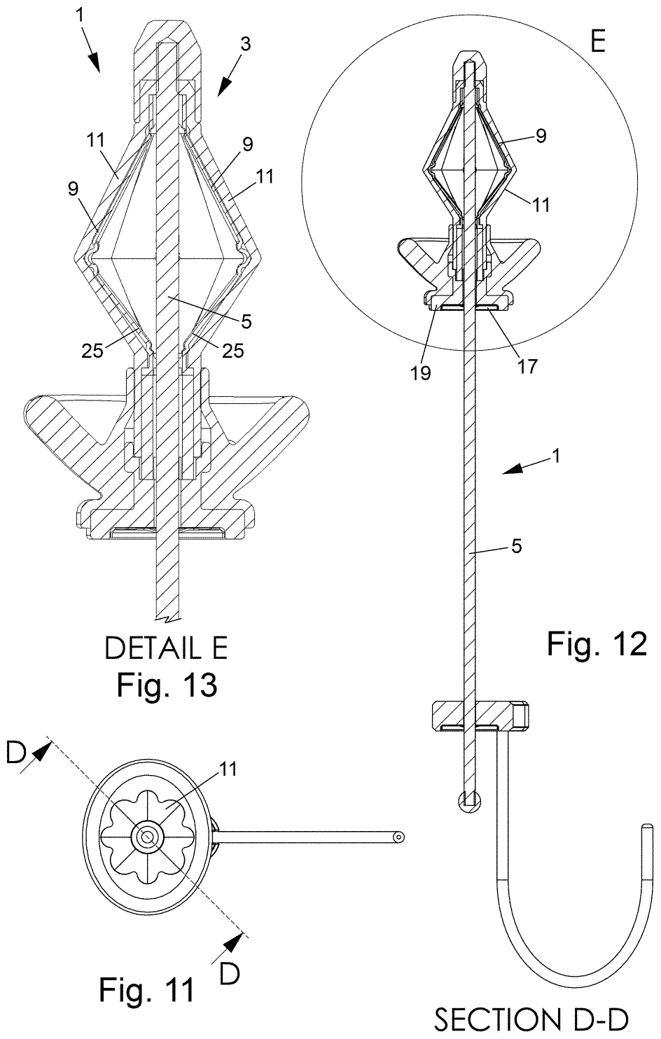

FIG. 11 is a top plan view of the anchor according to the first embodiment of the invention in stage 2;

FIG. 12 is a cross-sectional view along D-D in FIG. 11;

FIG. 13 is fragmentary view of FIG. 12 showing Detail E;

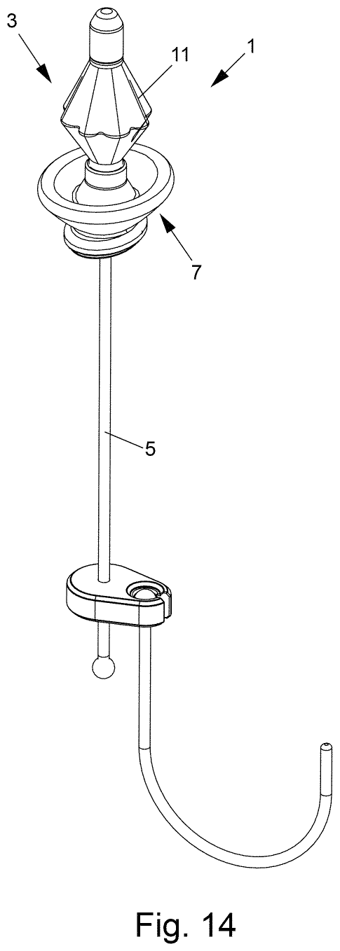

FIG. 14 is an isometric view from above of the anchor of FIG. 11;

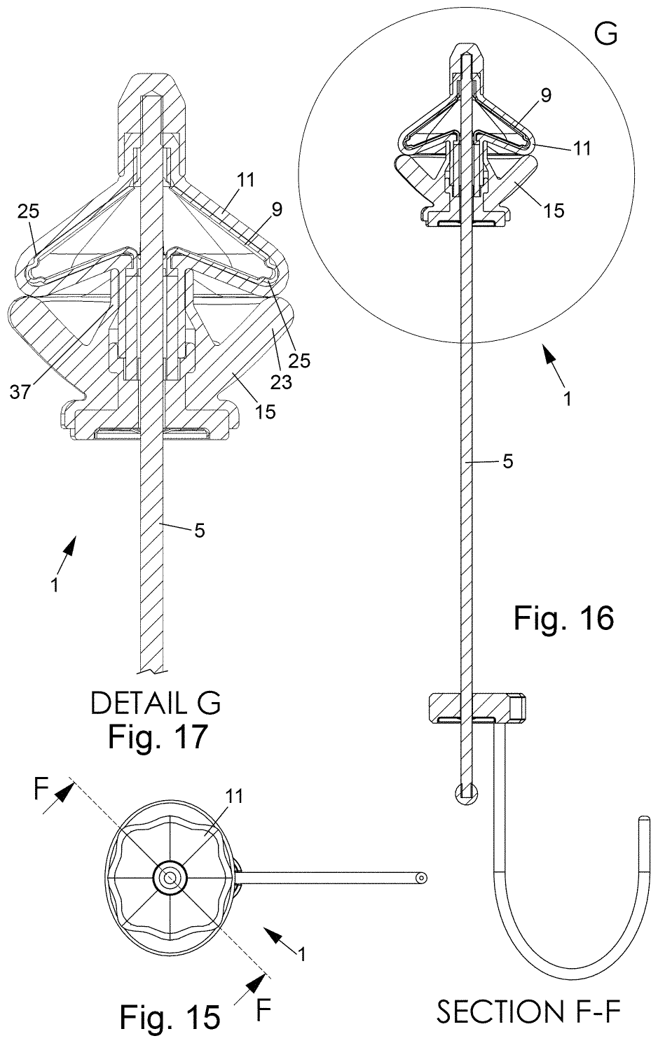

FIG. 15 is a top plan view of the anchor according to the first embodiment of the invention in stage 3;

FIG. 16 is a cross-sectional view along F-F in FIG. 15;

FIG. 17 is fragmentary view of FIG. 16 showing Detail G;

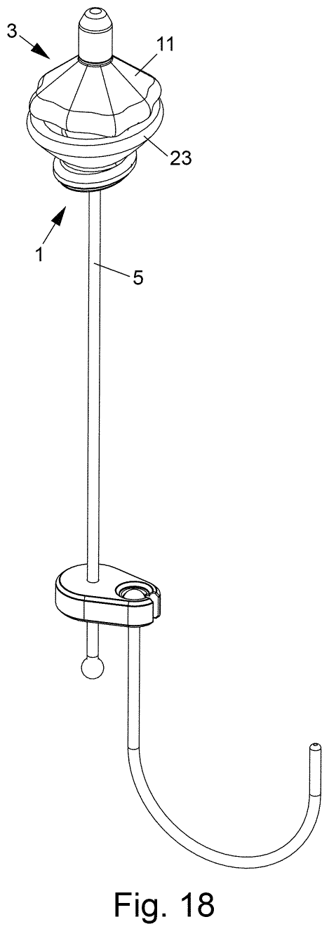

FIG. 18 is an isometric view from above of the anchor of FIG. 15;

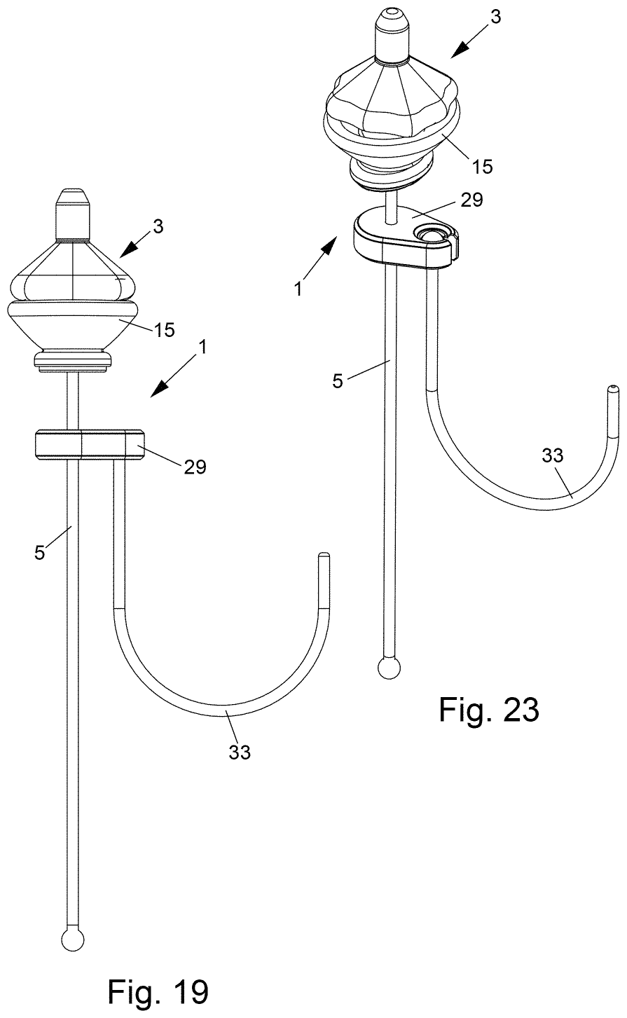

FIG. 19 is a side elevation view of the anchor according to the first embodiment of the invention in stage 4;

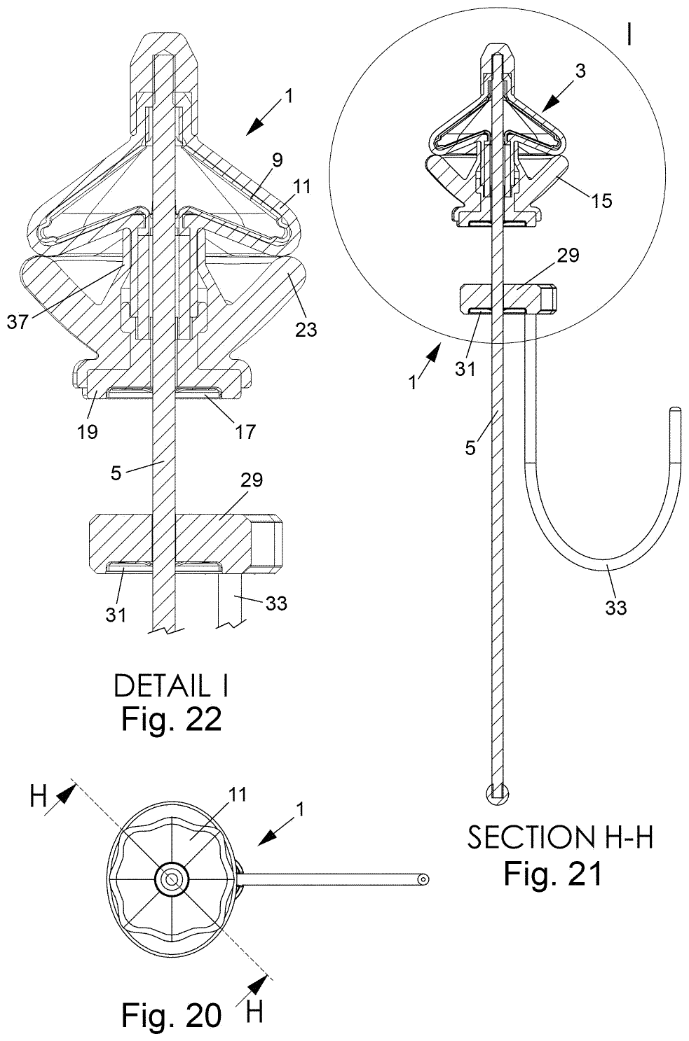

FIG. 20 is a top plan view of the anchor of FIG. 19;

FIG. 21 is a cross-sectional view along H-H in FIG. 20;

FIG. 22 is fragmentary view of FIG. 21 showing Detail I;

FIG. 23 is an isometric view from above of the anchor of FIG. 19;

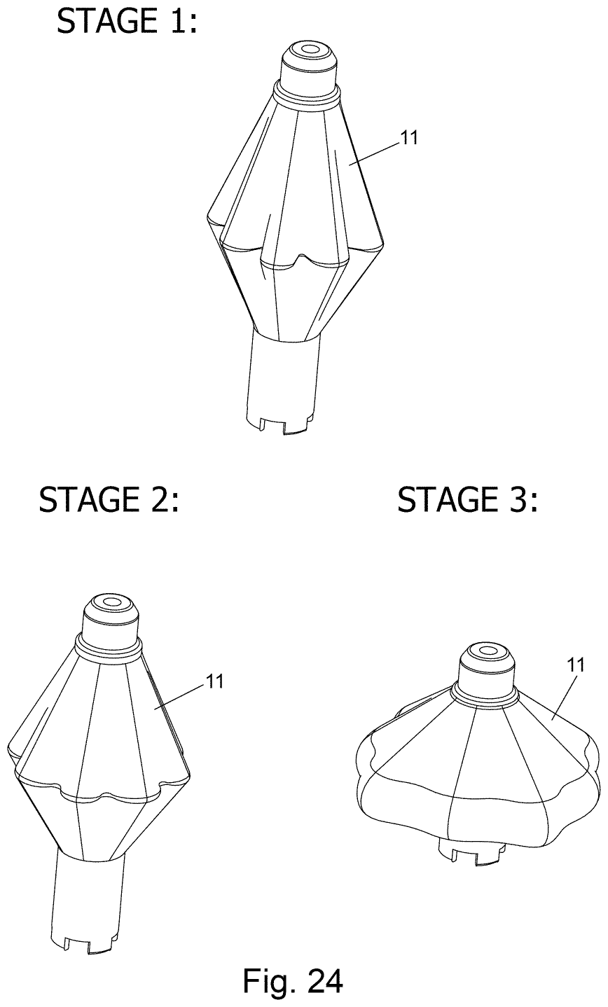

FIG. 24 is an isometric view from above of the outer part of the expanding part of the anchor according to the first embodiment of the invention in stages 1, 2 and 3;

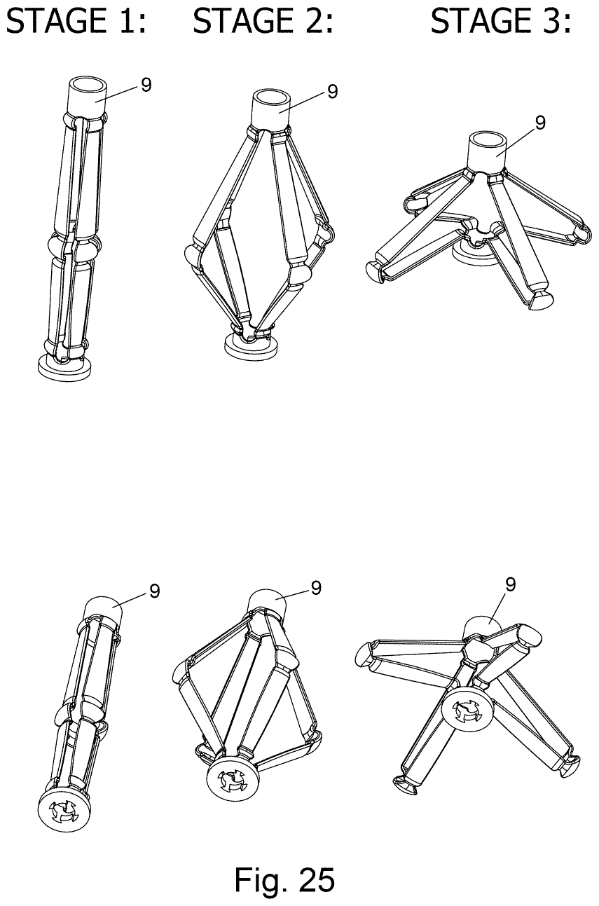

FIG. 25 are isometric views from above and below of the inner part of the expanding part of the anchor according to the first embodiment of the invention in stages 1, 2 and 3;

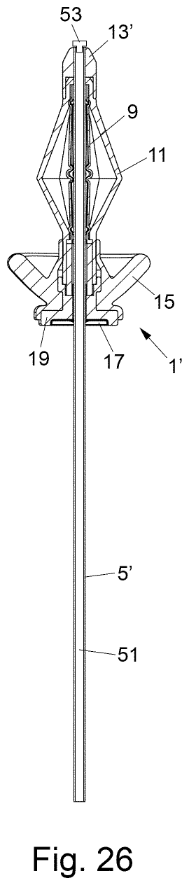

FIG. 26 is a cross-sectional view of the anchor according to the second embodiment of the invention in stage 1;

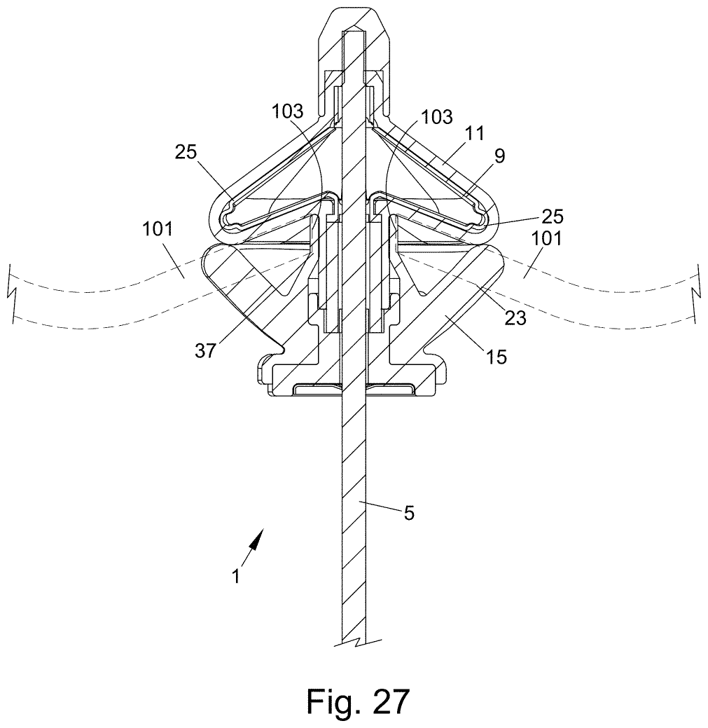

FIG. 27 is a fragmentary view of FIG. 16 showing Detail G but with a roof panel shown in dotted lines;

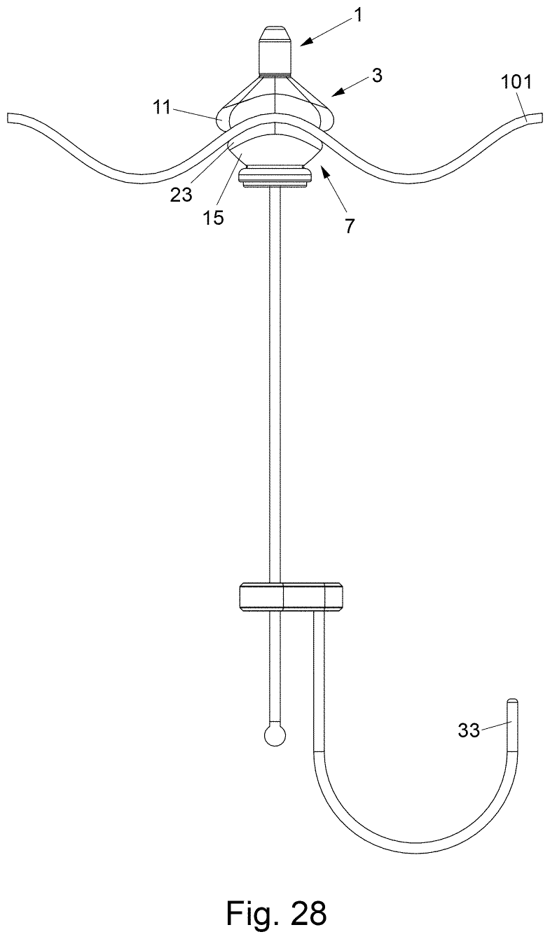

FIG. 28 is a side elevation view of the anchor according to the first embodiment of the invention in stage 3 in a roof panel;

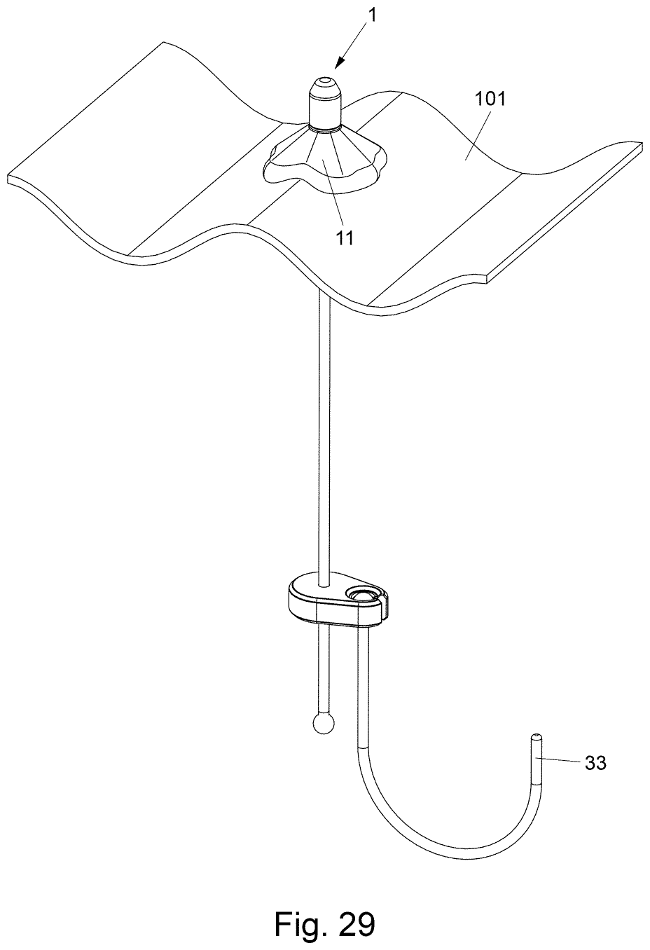

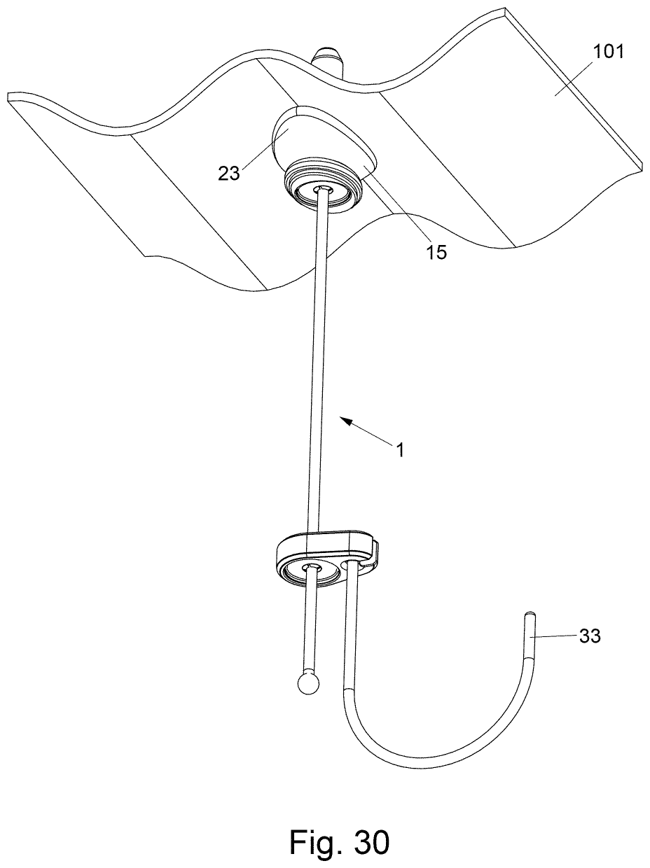

FIG. 29 is an isometric view from above of the anchor and roof panel of FIG. 28; and

FIG. 30 is an isometric view from below of the anchor and roof panel of FIG. 28.

Referring to FIG. 1, a roof hole sealing anchor 1 is shown. The anchor 1 comprises an expanding part shown generally at 3. The expanding part 3, when expanded, forms a hood and seals the hole from one (first) side. The anchor is shown in stage 1 in which the expanding part 3 is shown in its contracted condition. The expanding part 3 has above it a cap 13 which covers the top end of the expanding part 3.

Below the expanding part 3 in FIG. 1 is a member 5 in the form of a rod. The rod 5 passes through the expanding part 3, as shown in FIG. 4, from below the expanding part 3 to above the expanding part 3 and into the cap 13. The rod 5 is threadedly received in the cap 13.

Referring to FIG. 1 again, directly below the expanding part 3 is a positioner shown generally at 7. The positioner 7 engages the other (second) side of the hole and prevents movement of the expanding part 3 away from the one side of the hole. The positioner comprises a lower seal 15. The lower seal 15 is made of silicone rubber.

As shown in FIG. 5, the lower seal 15 has an outer annular lip 23 which forms a part of a cone: moving from the fixed end to the free end of the lip 23, the lip moves laterally outwards away from the centre. The lower seal 15 also has an inner annular lip 37 which forms a part of a cone: moving from the fixed end to the free end of the lip 37, the lip moves laterally inwards towards from the centre.

The anchor 1 is configured so that the expanding part 3 in its second, expanded condition and the lower seal 15 compress the roof part which has the hole so that the expanding part 3 and the lower seal 15 provide a tight seal against the roof part to prevent ingress of water. Both the outer annular lip 23 and inner annular lip 37 may compress the roof part and form tight seals against the roof part. In that case, there would be three seals compressing the roof part to prevent ingress of water, namely the expanding part 3, the inner annular lip 37 and the outer annular lip 23.

FIG. 5 shows the expanding part 3 comprising an inner part 9, and an outer sealing part 11 in the form of a sleeve. In the present embodiment, the outer part 11 is made of silicone rubber. In the present embodiment, the inner part 9 is made of stainless steel and has four legs 25 which run in a longitudinal direction and are spaced around the circumference of the inner part 9 and rod 5. The legs 25 have a bent section halfway along their length at the place they are intended to bend in use. Conveniently, the bent section curves laterally outwards and keeps this shape after the legs 25 have bent in use. This means there is no sharp edge to cut the rubber of the outer part 11. In use, the legs 25 can bend and expand laterally outwards which pushes the outer part 11 laterally outwards. Below the inner part 9 is a tubular spacer 21, and below the spacer 21 is a base plate 19 which also acts as a spacer. On the bottom of the base plate 19 is a recess in which an upper locking washer or “sliplock” 17 is located. The rod 5 runs in sequence bottom to top through the washer 17, the base plate 19, the spacer 21, the inner and outer parts 9 and 11 and the cap 13.

The inner lip 37 of the lower seal 15 forms an annular seal around the outside of the lower end of the outer part 11 of the expanding part 3.

As show in FIGS. 1 and 2, the outer part 11 is folded when in its contracted condition to form folds 47 running longitudinally. In the present embodiment, sixteen folds 47 are provided, as shown in FIG. 2, but a different number of folds may be provided. During expansion of the outer part 11, the folds 47 unfold to allow the outer part 11 to expand.

The washer 17 controls the sliding: The washer 17 prevents sliding downwards. The washer 17 has teeth 47 as shown in FIG. 9. The teeth 47 are provided on the inner circumferential surface of the washer 17 to engage the rod 5. The teeth 47 point along the rod 5 (downwards in the present embodiment) to lock the washer 17 against sliding downwards along the rod 5. The washer 17 can slide along the rod 5 in the other direction (upwards) but in the present embodiment this requires considerable force and may require the user to use a setting tool. In the present embodiment, a force of about 0.14 kN is required to move the washer 17 up the rod 5.

The base plate 19 is made of polycarbonate and so does not deform significantly when compressed.

Referring to FIG. 4, towards to bottom of the rod 5 is a bottom adjustor or plate 29 through which the rod 5 runs. On the bottom surface of the plate 29 is a recess in which a lower locking washer or “sliplock” 31 is located which acts as a stop. The lower locking washer 31 in the present embodiment is identical to the upper locking washer 17. The plate 29 is adapted to be slidable along the rod 5, but the lower washer 31 controls the sliding: The washer 31 prevents sliding downwards. The washer 31 has teeth 49 as shown in FIG. 9. The teeth 49 are provided on the inner circumferential surface of the washer 31 to engage the rod 5. The teeth 49 point along the rod 5 (downwards in the present embodiment) to lock the washer 31 against sliding downwards along the rod 5. The washer 31 allows sliding upwards but in the present embodiment this requires considerable force and may require the user to use a setting tool. The plate can also be rotated around the longitudinal axis of the rod 5, which is the direction in which the rod 5 extends.

The plate 29 is made of polycarbonate and so does not deform significantly when subjected to bending force.

At the bottom end of the rod 5 is a rod ball nut 27 which is screwed onto the rod 5. The nut 27 prevents the plate 29 from sliding off the end of the rod 5.

Connected to the rod 5 by the plate 29 is a wire hook 33. The hook 33 is open from above so as to engage the bottom surface of a purlin in a roof structure. As best shown in FIGS. 8 and 10, at one end of the hook 33 is a hook ball nut 35 which is received in a socket 39 in the plate 29 to form a ball joint 45. The nut 35 is screwed onto the wire of the hook 33. The plate 29 has a vertical slit 41 leading to the socket 39 through which the hook 33 can be passed into the socket 39. At the bottom of the socket 39 is an opening 43, shown in FIG. 9, which is larger than the wire of the hook 33 so that the wire can move in the opening 43, but smaller than the ball nut 35 so the ball nut 35 is retained in the socket 39.

FIG. 4 shows an axis X of the rod 5 which is in the direction in which the rod 5 extends. Also shown is an axis Y of the hook 33 which is the axis of the main straight section of wire of the hook 33. The ball joint 45 allows the hook 33 to be adjusted so as to adjust the angle between the axes X and Y. This adjustment could be to move the bottom of the hook 33 right in FIG. 4 about the ball joint 45, or it could be to move the bottom of the hook 33 away from the viewer of FIG. 4 or in a different direction.

The operation of the anchor 1 will now be described.

The anchor 1 in stage 1 (as shown in FIGS. 1-9) is inserted into a hole in, for example, a roofing panel. The panel may be of the undulating type. The hole needs to be larger than the maximum external lateral dimension of the expanding part 3, but smaller than the maximum external lateral dimension of the inner annular lip 37 in order to ensure that the three seals seal the hole. In the present embodiment, the anchor 1 can be used to seal holes from 8-15 mm in diameter.

The anchor 1 is inserted so that the expanding part 3 is on the top side of the hole, whereas the positioning part 7 is on the bottom side. The user then holds the positioner 7 while pulling the rod 5 downwards through the positioner 7. The user may push against the washer 17 or base plate 19 while pulling the rod 5. The washer 17 or base plate 19 then (via the spacer 21) pushes against the bottom of the inner part 9 of the expanding part 3. The inner part 9 buckles in the middle so that the middle parts of the legs 25 bend outwards while the top and bottom parts do not move outwards. The top part of the inner part 9 is fixed to the top of the rod 5 and moves closer to the bottom part of the inner part 9 along with the top of the rod 5. The legs 25 push the outer sealing part 11 of the expanding part 3 outwards to increase its external lateral dimensions. The expanding part 3 is shown in a semi-expanded condition (stage 2) in FIGS. 11 to 14.

Continued pulling of the rod 5 causes continued expansion of the expanding part 3 until it reaches its fully expanded condition (stage 3) as shown in FIGS. 15 to 18. The legs 25 of the inner part 9 are fully expanded. The laterally outermost part of the inner part 9 is below the formerly bottom part of the inner part 9 and below the adjacent part about which the bending occurs.

The lateral dimension in one direction of the expanding part 3 is only slightly smaller than that of the lower seal 15. The expanding part 3 now covers the entire perimeter of the hole to prevent ingress of water. The inner annular lip 37 of the lower seal 15 is received within the hole and passes through the hole to protrude to the top side, below the expanding part 3. This provides improved water-tightness. The outer annular lip 23 of the lower seal 15 also covers the entire perimeter of the hole to prevent ingress of water.

The pulling of the rod 5 causes the roofing panel to be compressed between the expanding part 3 and the positioner 7 (in particular, the lower seal 5). The expanding part 3 forms a first seal against ingress of water through the roofing panel. The inner annular lip 37 provides a second seal against ingress of water through the roofing panel. The outer annular lip 23 provides a third seal against ingress of water through the roofing panel.

Finally, the lower plate 29 and washer 31 are pushed upwards along the rod 5 until they reach their desired position. This is shown in FIGS. 20 to 23. The hook 33 may be hooked around the bottom of a purlin and its angle adjusted when doing so by rotation about the ball joint 45. The roofing panel is thereby fixed to the purlin by the anchor 1.

FIGS. 24 and 25 illustrate the inner and outer parts 9 and 11 of the expanding part 3 as they expand from stage 1 to stage 3.

FIG. 26 is a cross-sectional view of the roof hole sealing anchor 1′ according to the second embodiment of the invention in stage 1. FIG. 26 is the same view as FIG. 4 except that it is of the second embodiment rather than the first.

As shown in FIG. 26, the roof hole sealing anchor 1′ has a similar structure to that of the roof hole sealing anchor 1 of the first embodiment, and only differences will be described. The device 1′ of the second embodiment allows liquid such as water to flow through the device 1′ from inside the building to outside the building. The water could be used, for example, to flush out gutters, or the liquid could be weed killer for clearing the roof of vegetation. The liquid can pass through the device 1′ from the side of the hole on the inside of the building, through the hole bypassing the seals provided by the device, to the outside of the building to the other side of the hole.

The anchor 1′ fixes to a roof panel and provides a fixing point for pipework supplying the liquid. The pipework is not shown in FIG. 26.

A hollow shaft 5′ is used instead of the solid rod 5 of the first embodiment. No hook 33 is provided at the bottom end of the hollow shaft 5′. The shaft 5′ is hollow from one end to the other. The cap 13′ has a channel so that the liquid can flow upwards from the top end of the hollow shaft 5′.

On top of the cap 13′ is provided a one-way valve 53. The one-way valve 53 is not shown in cross-section in FIG. 26. A passageway 51 extends from the bottom end of the shaft 5′ to outlet of the one-way valve 53. The one-way valve 53 allows the liquid to flow out of the passageway 51 (i.e. from inside the building to out) and prevents rainwater or other liquids from flowing into the passageway 51 (i.e. from outside the building to in).

In use, the device 1′ is installed in the same way in stages 1 to 3 as the anchor 1 of the first embodiment. The lower seal 15 and outer sealing part 11 of the expanding part 3 provide the same sealing effect as for the first embodiment, and the one-way valve 53 prevents liquid from flowing from outside the building to in. Accordingly, the device 1′ seals the hole.

Pipework is then connected to the bottom end of the hollow shaft 5′ which is connected in turn to a source of liquid.

When it is desired to flush out gutters for example, liquid is pumped along the pipework, along the passageway 51 until it passes out of the one-way valve 53 and onto the roof.

FIG. 27 shows the anchor 1 of the first embodiment with a roof panel 101 superimposed on top and shown in dotted lines. In reality, there would be some deformation of the outer lip 23 and inner lip 37 of the lower seal 15 to accommodate the roof panel 101, but this is not shown in FIG. 27.

As FIG. 27 shows, on the left and right sides, the outer part 11 of the expanding part 3 overlaps the edge of the hole 103. That is, the most laterally outward part of the outer part 11 is outside the perimeter of the hole 103. The hole 103 is circular in plan, and the outer part 11 is approximately circular in plan and covers the entire perimeter of the hole 103 to seal the hole 103. Similarly, on the left and right sides, the outer lip 23 of the lower seal 15 overlaps the edge of the hole 103, as does the base of inner lip 37. The outer lip 23 of the lower seal 15 covers the entire perimeter of the hole 103 to seal the hole 103. The inner seal 37 also seals the entire periphery of the hole 103.

FIGS. 28 to 30 show the anchor 1 of the first embodiment with the roof panel 101 shown in solid lines. The roof panel 101 has an undulating shape. The deformation of the outer part 11 of the expanding part 3 and the lower seal 15 around the roof panel 101 is shown in FIGS. 28 to 30. In particular, FIGS. 28 and 29 show the peripheral edge of the outer part 11 curving to follow the curvature of the roof panel 101. FIGS. 28 and 30 show the peripheral edge of outer lip 23 curving to follow the curvature of the roof panel 101.

In the first and second embodiments, the following elements (where present) are all made of stainless steel: rod 5, inner part 9 of expanding part 3, cap 13, spacer 21, rod ball nut 27, hook 33 and hook ball nut 35. However, one or more of those elements may be made of another material, such as antimicrobial copper. For example, one of the copper alloys that have been granted a registration by the US Environmental Protection Agency (EPA) permitting them to be marketed in the US with public health claims could be used.

In the first and second embodiments, the following elements (where present) are made of galvanised steel: the upper washer 17 and lower washer 31. However, one or both of those elements may be made of another material, such as antimicrobial copper. For example, one of the copper alloys that have been granted a registration by the US Environmental Protection Agency (EPA) permitting them to be marketed in the US with public health claims could be used.

In the first embodiment, the rod 5 protrudes from the hole on the second side of the hole when the expanded part 3 is expanded and provides a point for anchoring objects to the roofing panel or wall panel which has the hole, or a point by which the roofing panel or wall panel can be anchored to another object on the second side of the hole. In other embodiments, the member or another part of the device may extend from the expanding part away from the hole on the first side of the hole (that is, externally of the building, and upwards in the case a hole in a roof) when the expanded part is expanded and provides a point for anchoring objects to the roofing panel or wall panel on the first side of the hole. For example, solar panel mountings, guttering or other external fittings can be anchored to the roofing panel. This avoids the need for additional fixing holes to anchor those fittings.

In the first embodiment, the hook 33 is curved in a J shape, but it may form a J with only straight sections (i.e. no curved sections) or take a different shape.

In the second embodiment, a one-way valve 53 is provided in the anchor 1′. Alternatively, a one-way valve could be provided in the pipework upstream of the anchor 1′.

In the first embodiment, a cap 13 is screwed onto the top end of the rod 5. Alternatively, the cap 13 may be dispensed with, and the end of the rod 5 may be expanded to have a greater width than the rest of it, for example by compressing the rod 5 in a longitudinal direction. When the rod 5 is pulled, the expanded portion, in the same ways as the cap 13, prevents the end of the rod 5 sliding through expanding part 3 and abuts the top end of the expanding part 3 to cause the expanding part 3 to expand.

In addition, the rod ball nut 27 may be dispensed with and the lower washer 31 may be relied upon to prevent the bottom plate 29 from sliding off the rod 5 which may make it easier to use a setting tool. Alternatively, the bottom end of the rod 5 may be expanded in a similar way to the top end. By expanding the top and bottom ends of the rod 5 or simply dispensing with the rod ball nut 27, manufacturing costs can be reduced in comparison to screw-on components.

The embodiments of the present invention have been described purely by way of example, and various modifications, additions and/or omissions will present themselves to one skilled in the art, all of which form part of the invention, together with their equivalents.

### LIST OF REFERENCE NUMERALS

1, 1′ anchor
3 expanding part
5, 5′ rod or shaft (member)
7 positioner
9 inner part (of expanding part 3)
11 outer part (of expanding part 3)
13, 13′ cap
15 lower seal
17 upper washer
19 base plate
21 spacer
23 outer lip (of lower seal 15)
25 legs
27 rod ball nut
29 bottom plate
31 lower washer
33 hook
35 hook ball nut
37 inner annular lip (of lower seal 15)
39 socket
41 slit
43 opening
45 ball joint
47 teeth (of washer 17)
49 teeth (of washer 31)
51 passageway
53 one-way valve
101 roof panel
103 hole

The application discloses the inventions defined in the following clauses:

1. A roof or wall hole closing device, the device comprising:
an expanding part to close the hole from one side, the expanding part being expandable from a first, contracted condition in which it can be passed through the hole, to a second, expanded condition in which it cannot be passed through the hole and in which it covers and closes the hole in a covering and closing position on a first side of the hole, the expanding part having an inner part and an outer sealing part, and during expansion of the expanding part the inner part moves laterally outwards which moves the outer sealing part laterally outwards;
a member passing into the expanding part, the expanding part being expandable by pulling the member in an outwards direction with respect to the expanding part through the expanding part and through the hole; and
a positioner to engage against a second side of the hole to prevent movement of the expanding part from its covering and closing position in its second, expanded condition.

2. A device according to clause 1, wherein substantially all of the perimeter of the expanding part moving laterally outwards during expansion so that the expanding part covers the entire perimeter of the hole in the covering position on the first side of the hole in the second, expanded condition.

3. A device according to clause 1 or 2, wherein the device is a roof or wall hole closing anchor.

4. A roof or wall hole closing anchor, the anchor comprising:
an expanding part to close the hole from one side, the expanding part being expandable from a first, contracted condition in which it can be passed through the hole, to a second, expanded condition in which it cannot be passed through the hole, substantially all of the perimeter of the expanding part moving laterally outwards during expansion so that the expanding part covers the entire perimeter of the hole and closes the hole in a covering and closing position on a first side of the hole in the second, expanded condition;
a member passing into the expanding part, the expanding part being expandable by pulling the member in an outwards direction with respect to the expanding part through the expanding part and through the hole; and
a positioner to engage against a second side of the hole to prevent movement of the expanding part from its covering and closing position in its second, expanded condition,
the device being configured so that, when the expanding part is in its second, expanded condition, the member is not retracted into the expanding part upon release of the pulling.

5. An anchor according to clause 4, wherein the expanding part has an inner part and an outer sealing part, and during expansion of the expanding part the inner part moves laterally outwards which moves the outer sealing part laterally outwards.

6. A device or anchor according to any one of clauses 1, 2, 3 or 5, wherein the outer sealing part is folded when the expanded part is in the first, contracted condition.

7. An device or anchor according to clause 6, wherein the outer sealing part is folded when the expanded part is in the first, contracted condition to form at least one fold running longitudinally.

8. A device or anchor according to any one of clauses 1-3 or 5-7, wherein the outer sealing part of the expanding part comprises an elastomeric material.

9. A device or anchor according to any preceding clause, wherein the expanding part comprises an elastomeric material.

10. A device or anchor according to any preceding clause, wherein the expanding part plastically deforms so that the member is not retracted into the expanding part, when the expanding part is in its second, expanded condition, upon release of the pulling.

11. A device or anchor according to any preceding clause, wherein the positioner comprises a stop which prevents movement of the member relative to the positioner in order to prevent movement of the expanding part from its covering position in which it closes the hole.

12. A device or anchor according to clause 11, wherein the stop is provided to prevent the member being retracted into the expanding part, when the expanding part is in its second, expanded condition, upon release of the pulling.

13. A device or anchor according to any preceding clause, wherein the positioner comprises a seal to seal the second side of the hole.

14. A device or anchor according to clause 13, wherein the seal is configured to be received within the hole.

15. A device or anchor according to clause 13 or 14, wherein the seal is configured to engage the roof or wall part which has the hole outside the perimeter of the hole.

16. A device or anchor according to any preceding clause, wherein the member is a rod or shaft.

17. A device or anchor according to any preceding clause, wherein a nut or cap is attached over the free end of the expanding part.

18. An anchor according to any preceding clause, comprising an attachment part connected to the member so as to be supported by the member, for attaching an object to the anchor on the second side of the hole.

19. An anchor according to clause 18, wherein the attachment part is configured to engage or receive a part of a roof framework to attach the roof framework to the anchor.

20. An anchor according to clause 18 or 19, wherein the position of the attachment part relative to the member is adjustable by pulling the attachment part along the member or away from the hole.

21. An anchor according to clause 18, 19 or 20, wherein:
the attachment part has an axis;
the member is configured to extend away from the hole on the second side of the hole when the anchor is anchored in the hole;
the member has an axis in the direction in which it extends; and
the orientation of the attachment part is adjustable so as to adjust an angle between its axis and the axis of the member.

22. A roof or wall hole anchor, the anchor comprising:
a member configured to extend away from the hole on one side of the hole when the anchor is anchored in the hole, the member having an axis in the direction in which it extends; and
an attachment part connected to the member so as to be supported by the member, for attaching an object to the anchor on the one side of the hole, the attachment part having an axis,
wherein the orientation of the attachment part is adjustable so as to adjust an angle between its axis and the axis of the member.

23. An anchor according to clause 22, wherein a pivot is provided which allows adjustment of the orientation of the attachment part.

24. An anchor according to clause 22 or 23, wherein a ball joint is provided which allows adjustment of the orientation of the attachment part.

25. An anchor according to clause 24, wherein the ball of the ball joint can be clipped into the socket of the ball joint.

26. An anchor according to any one of clauses 22 to 25, wherein the position at which the attachment part is connected to the member is adjustable.

27. An anchor according to any one of clauses 22 to 25, wherein the attachment part comprises a hook.

28. A roof or wall hole closing device, the device comprising:
an expanding part to close the hole from one side, the expanding part being expandable from a first, contracted condition in which it can be passed through the hole, to a second, expanded condition in which it cannot be passed through the hole and in which it covers and closes the hole in a covering and closing position on a first side of the hole; and
a positioner to engage against a second side of the hole to prevent movement of the expanding part from its covering and closing position in its second, expanded condition,
wherein the device has a passageway having an inlet and an outlet, the passageway passing through the expanding part, the inlet and the outlet being arranged so that liquid can pass from the inlet on the second side of the hole, through the hole and expanding part to the first side of the hole, and out of the outlet only when the liquid reaches the side of the expanding part away from the hole.

29. A roof or wall hole closing device according to clause 28, further comprising a one-way valve in the passageway between the inlet and the outlet, to prevent liquid from passing from the outlet to the inlet.

30. A roof or wall hole closing device according to clause 28 or 29, further comprising a member passing through the expanding part, the expanding part being expandable by pulling the member in an outwards direction with respect to the expanding part through the expanding part and through the hole,
wherein the passageway passes through the expanding part inside the member.

1-29. (canceled)

30. A roof or wall hole closing device, the device comprising:
an expanding part to close the hole from one side, the expanding part being expandable from a first, contracted condition in which it can be passed through the hole, to a second, expanded condition in which it cannot be passed through the hole and in which it covers and closes the hole in a covering and closing position on a first side of the hole, the expanding part having an inner part and an outer sealing part, and during expansion of the expanding part the inner part moves laterally outwards which moves the outer sealing part laterally outwards;
a member passing into the expanding part, the expanding part being expandable by pulling the member away from the expanding part through the expanding part and through the hole; and
a positioner to engage against a second side of the hole to prevent movement of the expanding part from its covering and closing position in its second, expanded condition,
wherein the positioner comprises a seal to seal the second side of the hole.

31. A device according to claim 30, wherein substantially all of the perimeter of the expanding part moving laterally outwards during expansion so that the expanding part covers the entire perimeter of the hole in the covering position on the first side of the hole in the second, expanded condition.

32. A device according to claim 30, wherein the device is a roof or wall hole closing anchor.

33. A roof or wall hole closing anchor, the anchor comprising:
an expanding part to close the hole from one side, the expanding part being expandable from a first, contracted condition in which it can be passed through the hole, to a second, expanded condition in which it cannot be passed through the hole, substantially all of the perimeter of the expanding part moving laterally outwards during expansion so that the expanding part covers the entire perimeter of the hole and closes the hole in a covering and closing position on a first side of the hole in the second, expanded condition;
a member passing into the expanding part, the expanding part being expandable by pulling the member away from the expanding part through the expanding part and through the hole; and
a positioner to engage against a second side of the hole to prevent movement of the expanding part from its covering and closing position in its second, expanded condition,
the anchor being configured so that, when the expanding part is in its second, expanded condition, the member is not retracted into the expanding part upon release of the pulling,
wherein the positioner comprises a seal to seal the second side of the hole.

34. An anchor according to claim 33, wherein the expanding part has an inner part and an outer sealing part, and during expansion of the expanding part the inner part moves laterally outwards which moves the outer sealing part laterally outwards.

35. A device according to claim 30, wherein the outer sealing part is folded when the expanded part is in the first, contracted condition.

36. An device according to claim 35, wherein the outer sealing part is folded when the expanded part is in the first, contracted condition to form at least one fold running longitudinally.

37. A device according to claim 30, wherein the outer sealing part of the expanding part comprises an elastomeric material.

38. A device according to claim 30, wherein the expanding part comprises an elastomeric material.

39. A device according to claim 30, wherein the expanding part plastically deforms so that the member is not retracted into the expanding part, when the expanding part is in its second, expanded condition, upon release of the pulling.

40. A device according to claim 30, wherein the positioner comprises a stop which prevents movement of the member relative to the positioner in order to prevent movement of the expanding part from its covering position in which it closes the hole.

41. A device according to claim 40, wherein the stop is provided to prevent the member being retracted into the expanding part, when the expanding part is in its second, expanded condition, upon release of the pulling.

42. A device according to claim 30, wherein the seal is configured to be received within the hole.

43. A device according to claim 30, wherein the seal is configured to engage the roof or wall part which has the hole outside the perimeter of the hole.

44. A device according to claim 30, wherein the member is a rod or shaft.

45. A device according to claim 30, wherein a nut or cap is attached over the free end of the expanding part.

46. An anchor according to claim 32, comprising an attachment part connected to the member so as to be supported by the member, for attaching an object to the anchor on the second side of the hole.

47. An anchor according to claim 46, wherein the attachment part is configured to engage or receive a part of a roof framework to attach the roof framework to the anchor.

48. An anchor according to claim 46, wherein the position of the attachment part relative to the member is adjustable by pulling the attachment part along the member or away from the hole.

49. An anchor according to claim 46, wherein:
the attachment part has an axis;
the member is configured to extend away from the hole on the second side of the hole when the anchor is anchored in the hole;
the member has an axis in the direction in which it extends; and
the orientation of the attachment part is adjustable so as to adjust an angle between its axis and the axis of the member.
